(19) United States
(12) Patent Application Publication
(10) Pub. No.: US 2019/0300657 A1
(43) Pub. Date: Oct. 3, 2019

(54) METHOD FOR PRODUCING SOLID ACRYLIC ACID POLYMERS

(71) Applicant: BASF SE, Ludwigshafen am Rhein (DE)

(72) Inventors: Faissal-Ali El-Toufaili, Ludwigshafen (DE); Timo Laubscher, Landau (DE); Juergen Detering, Limburgerhof (DE); Martin Keller, Heidelberg (DE); Ines Debeasuvais De Vasconcelos, Ludwigshafen (DE); Dominik Lanzinger, Ludwigshafen (DE)

(21) Appl. No.: 16/317,128

(22) PCT Filed: Jul. 10, 2017
(86) PCT No.: PCT/EP2017/067252

§ 371 Date: Jan. 11, 2019

(30) Foreign Application Priority Data
Jul. 11, 2016 (EP) 16178838.5

(51) Int. Cl. C08J 3/12; C08F 6/02; C08L 33/02; C08J 3/05

(52) U.S. Cl. CPC C08J 3/12; C08F 6/02; C08J 2333/02; C08J 3/05; C08L 33/02

(57) ABSTRACT

Described herein is a process for preparing solid acrylic acid polymers including:
(a) preparing an aqueous acrylic acid polymer solution having a solids content of 30% to 70% by weight by free-radical polymerization,
(b) neutralizing the aqueous acrylic acid polymer solution at least partly by adding a base, which results in release of a heat of neutralization, and concentrating the aqueous acrylic acid polymer solution by exploiting the heat of neutralization to give a highly concentrated acrylic acid polymer solution having a solids content of 60% to 80% by weight,
(c) shaping and drying the highly concentrated acrylic acid polymer solution.

### FIELD OF INVENTION

The invention relates to a process for preparing solid acrylic acid polymers from aqueous solutions of the acrylic acid polymers.

### BACKGROUND

Homo- and copolymers based on acrylic acid find various uses in the form of aqueous solutions or in solid form as effective dispersants, scale inhibitors, rheology modifiers and processing auxiliaries. The fields of application are very different. Thus, washing compositions comprise these polymers in order to inhibit deposits of insoluble inorganic salts, for example calcium carbonate, on the laundry (called incrustation inhibitors), and in order to prevent graying of the laundry on account of their soil-dispersing action. In dishwashing tablets, the acrylic acid polymers are used to prevent organic and inorganic deposits on the ware and for reduction of water hardness. In industrial water treatment and seawater desalination, these polymers serve as very effective scale inhibitors. In the paper industry, they are very valuable in the production and stabilization of highly concentrated calcium carbonate and kaolin slurries.

In industry, the acrylic acid polymers are frequently prepared by free-radical solution polymerization in water. The molecular weight is frequently adjusted by using molecular weight regulators. The aqueous polymer solutions can be obtained in acidic form, in partly neutralized form or in neutralized form. (Partial) neutralization is generally accomplished using sodium hydroxide solution or potassium hydroxide solution.

The standard way of preparing solid, (partly) neutralized acrylic acid polymers is by spray drying or spray pelletization of a 30% to 45% by weight aqueous solution of the (partly) neutralized acrylic acid polymers. The drawback of this process is that large amounts of water have to be removed with considerable energy input and in a time-consuming manner, in order to obtain solid polymers.

JP2004002561 A describes a process for preparing highly concentrated polymer salt solutions based on (meth)acrylic acid, in which an acidic aqueous polymer solution is admixed with alkali metal hydroxide solution and the water vapor formed is removed.

CN102120795 A describes a process for concentrating acidic polymers based on acrylic acid and maleic acid, in which an aqueous solution of the polymers is heated under reduced pressure and the water vapor formed is removed.

### DESCRIPTION

It is an object of the invention to provide an inexpensive process for preparing solid acrylic acid polymers, which is notable for lower energy costs and shorter processing times.

The object is achieved by a process for preparing solid acrylic acid polymers having the steps of:
(a) preparing an aqueous acrylic acid polymer solution having a solids content of 30% to 70% by weight by free-radical polymerization,
(b) at least partly neutralizing the aqueous acrylic acid polymer solution by adding a base, which results in release of heat of neutralization, and concentrating the aqueous acrylic acid polymer solution by evaporating water to give a highly concentrated acrylic acid polymer solution having a solids content of 60% to 80% by weight,
(c) shaping and drying the highly concentrated acrylic acid polymer solution.

The aqueous acrylic acid polymer solution is concentrated by the evaporation of water. It is particularly advantageous to use the heat of neutralization released in the at least partial neutralization of the aqueous acrylic acid polymer solution for the concentration step.

The object is thus achieved by a process for preparing solid, (partly) neutralized acrylic acid polymers, in which the 30% to 70% by weight, especially 40% to 65% by weight, aqueous acidic acrylic acid polymer solution prepared by free-radical polymerization is concentrated during the (partial) neutralization, preferably with exploitation of the heat of neutralization, to 60% to 80% by weight, especially to 65% to 75% by weight, and the highly concentrated, highly viscous acrylic acid polymer solution thus prepared is subjected to drying and shaping to give solid acrylic acid polymers. Drying and shaping can be effected by various methods.

Preferably, step (b) is conducted in two component steps (b-1) and (b-2), in which case component step (b-1) comprises the mixing of the aqueous acrylic acid polymer solution with a base and the at least partial neutralization of the acrylic acid polymer solution, and component step (b-2) the concentration of the acrylic acid polymer solution that has been heated by the heat of neutralization by evaporating water. In general, component step (b-1) is conducted at a higher pressure than component step (b-2).

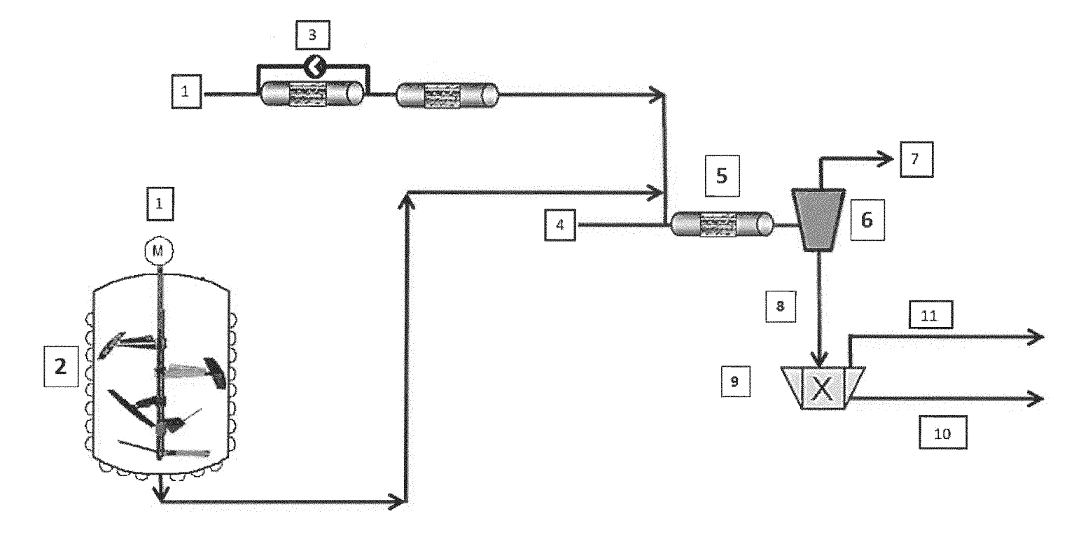

FIG. 1 shows, in schematic form, embodiments of the process of the invention.

FIG. 1 shows, specifically,
(a) the polymerization of acrylic acid (1) and optionally comonomers by means of semibatchwise mode in a stirred tank reactor (2) or continuously in tubular or loop reactors which have preferably been provided with internals for improved mixing and removal of heat (3),
(b-1) neutralization by rapid mixing of the acrylic acid polymer solution with sodium hydroxide solution (4) in a tubular or loop reactor (5),
(b-2) concentration with exploitation of the heat of neutralization in a gas separation vessel (6), releasing water vapor (7),
(c) drying and shaping of the concentrated solution (8) in a contact drier (9) to give solid acrylic acid polymer (10), with removal of water vapor (11).

In one variant, step (b-1) can also be effected in a stirred tank with a condenser with complete removal of heat, for example by wall cooling and evaporative cooling, and recycling of the condensed water. In this variant, the heat of neutralization is not exploited for concentration.

Step (b-2) can also be conducted in a stirred tank reactor, preferably in the stirred tank reactor used in step (a). In this case, the gas separation vessel is not a separate gas separation vessel but the stirred tank reactor itself.

Steps (b-1) and (b-2) can thus both be conducted in a stirred tank reactor. Preferably, step (b-1) is conducted in a tubular or loop reactor with internal mixing elements and step (b-2) in a gas separation vessel.

The essence of the invention is the controlled concentration of the aqueous polymer solution with exploitation of the heat of neutralization to give a highly concentrated polymer solution having a high viscosity, which can then be subjected to various drying and shaping methods.

The highly concentrated, highly viscous polymer solution which is obtained from the neutralization and concentration step (b) generally has a viscosity of 300 to 6000 mPas at 90° C. and a shear rate of 100 s⁻¹, measured with an Anton Paar MCR 52 viscometer with a CC27 spindle, and can be mechanically comminuted. Pelletizers are especially suitable for this purpose. Particles of the high-viscosity polymer solution are tacky but do not stick to surfaces having very low surface energy, for example Teflon. The particles likewise do not stick to surfaces having a temperature of more than 100° C., preferably more than 110° C. This is attributed to rapid surface drying of the particles. In addition, the surface drying of the particles can be achieved by means of a hot gas stream, for example of hot air or hot nitrogen or of mixtures thereof. By means of such a drying operation, it is possible to increase the solids content of the particles, such that the particles do not stick even after prolonged storage under air. For this purpose, the solids content of the dried acrylic acid polymers is generally at least 76% by weight, preferably from 80% to 100% by weight, more preferably from 85% to 95% by weight. These values relate to a fully neutralized acrylic acid homopolymer. In the case of copolymers, or in the case of incompletely neutralized acrylic acid homopolymers, the values for the required or preferred solids contents may differ.

The polymerization is effected in aqueous solution. Acrylic acid, alone or together with one or more different vinyl or acrylic monomers as comonomers, is converted by free-radical polymerization to a water-soluble acrylic acid polymer. The acrylic acid polymers may thus either be acrylic acid homopolymers or acrylic acid copolymers. Suitable comonomers are especially ethylenically unsaturated carboxylic acids such as methacrylic acid, 2-ethylacrylic acid, 2-propylacrylic acid, maleic acid or maleic anhydride, itaconic acid and fumaric acid. Further suitable comonomers are unsaturated sulfonic acids, salts of unsaturated sulfonic acids, unsaturated phosphonic acids and salts of unsaturated phosphonic acids, such as 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, vinylphosphonic acid, allylphosphonic acid and salts of the aforementioned acids. In general, the comonomer content is up to 30% by weight. The water-soluble acrylic acid polymers are uncrosslinked. In this respect, they differ from water-insoluble, crosslinked, water-swellable acrylic acid copolymers which are used as superabsorbers.

The polymerization is generally effected at constant temperature, but the temperature can also be varied if required during the polymerization. Preferably, the polymerization temperature varies within the range from 70 to 220° C. and especially within the range from 80 to 100° C.

The polymerization can be effected in the absence or presence of an inert gas. Typically, the polymerization is conducted in the presence of an inert gas. An inert gas is generally understood to mean a gas which does not enter into any reaction with the reactants, reagents or solvents involved in the reaction or the products formed under the given reaction conditions. Preference is given to using nitrogen as inert gas.

For preparation of the polymers, the monomers can be polymerized with the aid of initiators that form free radicals, also referred to hereinafter as free-radical initiators or initiators. Useful free-radical initiators for the free-radical polymerization in principle include any free-radical initiators which are essentially soluble in the reaction medium as exists at the time of their addition and have sufficient activity at the given reaction temperatures to initiate the polymerization. It is possible to use a single free-radical initiator or a combination of at least two free-radical initiators in the process according to the invention. In the latter case, the at least two free-radical initiators can be used in a mixture of preferably separately, simultaneously or successively, for example at different times in the course of the reaction.

Free-radical initiators which can be used for the free-radical polymerization include the peroxo and/or azo compounds that are customary for the purpose, for example hydrogen peroxide, alkali metal or ammonium peroxodisulfates (for example sodium peroxodisulfate), diacetyl peroxide, dibenzoyl peroxide, succinyl peroxide, di-tert-butyl peroxide, tert-butyl peroxybenzoate, tert-butyl peroxypivalate, tert-butyl peroxyneodecanoate, tert-butyl peroxy-2-ethylhexanoate, tert-butyl peroxymaleate, cumene hydroperoxide, diisopropyl peroxydicarbamate, bis(o-tolyl) peroxide, didecanoyl peroxide, dioctanoyl peroxide, tert-butyl peroctoate, dilauroyl peroxide, tert-butyl perisobutyrate, tert-butyl peracetate, di-tert-amyl peroxide, tert-butyl hydroperoxide, 2,2′-azobis-isobutyronitrile, 2,2′-azobis(2-amidinopropane) dihydrochloride (=azobis(2-methylpropion-amidine) dihydrochloride), azobis(2,4-di-methylvaleronitrile) or 2,2′-azobis(2-methylbutyronitrile).

Also suitable are initiator mixtures or redox initiator systems, for example ascorbic acid/iron(II) sulfate/sodium peroxodisulfate, tert-butyl hydroperoxide/sodium disulfite, tert-butyl hydroperoxide/sodium hydroxymethanesulfinate, H₂O₂/Cu^{I}.

In general, the amount of initiator system (initiator) used is from 0.01 to 10 pphm, preferably from 0.1 to 5 pphm, more preferably from 1 to 3 pphm (parts per hundred monomer=parts by weight per hundred parts by weight of monomer).

The polymerization can be effected without the use of a chain transfer agent or in the presence of at least one chain transfer agent. Chain transfer agents generally refer to compounds having high transfer constants that accelerate chain transfer reactions and hence bring about lowering of the degree of polymerization of the resulting polymers. The chain transfer agents can be distinguished between mono-, bi- and polyfunctional chain transfer agents according to the number of functional groups in the molecule, which can lead to one or more chain transfer reactions. Suitable chain transfer agents are described in detail, for example, by K. C. Berger and G. Brandrup in J. Brandrup, E. H. Immergut, Polymer Handbook, 3rd ed., John Wiley & Sons, New York, 1989, p. 11/81-11/141.

Examples of suitable chain transfer agents are aldehydes such as formaldehyde, acetaldehyde, propionaldehyde, n-butyraldehyde and isobutyraldehyde.

Chain transfer agents used may also be formic acid or salts or esters thereof, such as ammonium formate, 2,5-diphenyl-1-hexene, hydroxylammonium sulfate and hydroxylammonium phosphate.

Further suitable chain transfer agents are allyl compounds such as allyl alcohol and functionalized allyl ethers such as allyl ethoxylates, alkyl allyl ethers and glycerol monoallyl ethers.

Chain transfer agents used are preferably compounds comprising sulfur in bound form. Compounds of this kind are, for example, inorganic hydrogensulfites, disulfites and dithionites or organic sulfides, disulfides, polysulfides, sulfoxides and sulfones. These include di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-t-butyl trisulfide, dimethyl sulfoxide, dialkyl sulfide, dialkyl disulfide and/or diaryl sulfide. Suitable chain transfer agents are also thiols (compounds comprising sulfur in the form of SH groups, also referred to as mercaptans). Preferred chain transfer agents are mono-, bi- and polyfunctional mercaptans, mercaptoalcohols and/or mercaptocarboxylic acids. Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea, and alkyl mercaptans such as n-butyl mercaptan, n-hexyl mercaptan or n-dodecyl mercaptan. Examples of difunctional chain transfer agents containing two sulfur atoms in bound form are difunctional thiols, for example dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bisthioglycolate. Examples of polyfunctional chain transfer agents are compounds containing more than two sulfur atoms in bound form. Examples of these are trifunctional and/or tetrafunctional mercaptans.

More preferably, the chain transfer agent is selected from mercaptoethanol, mercaptoacetic acid, mercaptopropionic acid, ethylhexyl thioglycolate and sodium hydrogensulfite.

Preferred chain transfer agents are also hypophosphorous acid (phosphinic acid) and salts of hypophosphorous acid. A preferred salt of hypophosphorous acid is the sodium salt.

If a chain transfer agent is used in the process of the invention, the amount is typically 1 to 40 pphm (“parts per hundred monomer”, i.e. parts by weight based on hundred parts by weight of monomer composition). Preferably, the amount of chain transfer agent used in the process of the invention is in the range from 3 to 30 pphm, more preferably in the range from 5 to 12 pphm. It is also possible to conduct the polymerization without addition of a chain transfer agent.

The polymerization can be effected either continuously in a stirred tank in semibatchwise mode or continuously in tubular or loop reactors that have preferably been provided with internals for improved mixing and removal of heat.

The aqueous acrylic acid polymer solution prepared in step (a) comprises the acrylic acid polymer in acidic, non-neutralized or at most partly neutralized form. In general, the neutralization level is 0% to 30%, preferably 0% to 20%, especially 0% to 10%.

The weight-average molecular weight Mw of the acrylic acid polymer obtained in step (a) is generally 1000 to 100 000 g/mol, preferably 2000 to 70 000 g/mol and more preferably 3000 to 50 000 g/mol. In a particular embodiment, the weight-average molecular weight Mw is 3000 to 20 000 g/mol.

In step (b), the aqueous acrylic acid polymer solution obtained in step (a) is at least partly neutralized by adding a base, which releases heat of neutralization, and the aqueous acrylic acid polymer solution is concentrated, preferably with exploitation of the heat of neutralization, by the evaporation of water to give a highly concentrated acrylic acid polymer solution having a solids content of 60% to 80% by weight.

In general, step (b) is conducted in one step or in two component steps (b-1) and (b-2) that are separate in space and/or in time, where component step (b-1) comprises the mixing of the aqueous acrylic acid polymer solution with a base and the at least partial neutralization of the acrylic acid polymer and component step (b-2) the concentration of the acrylic acid polymer solution that has been heated by the heat of neutralization by evaporation of water. If step (b) is conducted in two separate component steps (b-1) and (b-2), component step (b-1) is conducted at a relatively high pressure, preferably of 1.5 to 10 bar, for example of 5 to 10 bar, and step (b-2) at a relatively low pressure, preferably of 1 to 5 bar, for example of 1 to 2.5 bar. The concentrating in step (b-2) thus comprises the expansion of the acrylic acid polymer solution that has been heated by the heat of neutralization in step (b-1) from a higher pressure to a lower pressure. The difference in pressure between steps (b-1) and (b-2) is generally 1 to 5 bar, preferably 1 to 2 bar.

Preferably, the aqueous acrylic acid polymer solution is heated in step (b-1) to a temperature in the range from 100 to 150° C., more preferably from 120 to 140° C.

In the performance of step (b), the mixing of the aqueous acrylic acid polymer solution with a base and the at least partial neutralization of the acrylic acid polymer and the concentration of the acrylic acid polymer solution that has been heated by the heat of neutralization by evaporation of water may be effected simultaneously or in overlapping periods of time. In this case, step (b) can be conducted either under reduced pressure or at room pressure or under elevated pressure, for example at 0.5 bar to 5 bar, preferably from 1 to 2.5 bar.

Preferably, step (b) comprises the steps of
(b-1) adding a base and mixing the base with the aqueous acrylic acid polymer solution at a pressure in the range from 5 to 10 bar and at least partly neutralizing and heating the aqueous acrylic acid polymer solution to a temperature in the range from 120 to 140° C.,
(b-2) expanding the aqueous acrylic acid polymer solution to a pressure in the range from 1 to 2.5 bar and concentrating it by evaporating water with exploitation of the heat of neutralization.

Specifically, steps (b-1) and (b-2) can be conducted as described below. The (partial) neutralization of the acrylic acid polymer is effected by adding a base or an aqueous solution of a base to the aqueous polymer solution. The concentration of the polymer solution is generally decided by the polymerization process. However, the concentration is within the range from 30% to 70% by weight, preferably within the range from 40% to 65% by weight. Bases used may be either organic bases such as amines or alkoxides, or the salts of weak organic acids, or else inorganic bases such as ammonia, sodium hydroxide or potassium hydroxide, other metal hydroxides, or else carbonates. Preference is given to using an aqueous sodium hydroxide solution, preference being given to a maximum NaOH concentration in order not to unnecessarily dilute the polymer solution. In order to achieve higher NaOH concentrations, it is also possible to use a heated NaOH solution.

Preferably, the heat released in the neutralization provides at least some of the heat input required for concentration of the polymer solution, which results at least in a reduction in any supply of external heat. The heat supplied additionally for heating of the polymer solution is generally not more than 90%, preferably not more than 80%, of the heat released by the neutralization. The (partial) neutralization up to a desired degree of neutralization can be effected in one or more steps. Preferably, the (partial) neutralization is conducted under elevated pressure, such that temperatures exceeding 100° C. are possible. The (partial) neutralization is preferably conducted in a tubular reactor having internal mixing elements. This tubular reactor enables rapid mixing of the polymer with the base. The tubular reactor may have internal or external cooling elements/heating elements in order to establish the desired temperature at the reactor outlet. The temperature at the reactor outlet is generally between 100° C. and the decomposition temperature of the acrylic acid polymer of about 250° C., preferably from 100 to 150° C., more preferably from 120 to 140° C.

The hot polymer solution obtained in the (partial) neutralization step (b-1) is expanded into a vessel (gas separation vessel) to a pressure of generally 1 to 5 bar, preferably from 1 to 2.5 bar, in the course of which some of the water evaporates and is removed. According to the invention, the solids content of the polymer solution increases here to 60% to 80% by weight, preferably to 65% to 75% by weight. The solution on exit from the gas separation vessel generally has a temperature of 50 to 150° C., preferably of 80 to 125° C. The solution is highly viscous under these conditions.

In a preferred embodiment of the process of the invention, step (b-1) is conducted in a tubular reactor having mixing elements and step (b-2) in a gas separation vessel.

A preferred base is aqueous sodium hydroxide solution, especially a 40% to 55% by weight sodium hydroxide solution, for example a 50% by weight sodium hydroxide solution.

In one embodiment of the process of the invention, in step (b) external heat is additionally supplied. In this case, it is possible to supply additional heat both in step (b-1) and in step (b-2). For example, the reactor used in step (b-1) can additionally be heated. It is also possible to additionally heat the gas separation vessel used in step (b-2). The additional heat supplied for heating of the polymer solution is generally not more than 90%, preferably not more than 80%, of the heat released by the neutralization.

In general, the neutralization level of the highly concentrated acrylic acid polymer solution is 30% to 100%, preferably 50% to 100%, especially 90% to 100%.

Subsequently, in a step (c), the highly concentrated acrylic acid polymer solution is shaped and dried. Shaping and drying can be conducted in a common process step or separate process steps.

It has been found that, surprisingly, the highly concentrated polymer solution can be dried and pelletized by the processes described below.

In general, the drying of the highly concentrated acrylic acid polymer solution in step (c) is conducted up to a solids content of 80% to 100% by weight.

In one embodiment of the process of the invention, the shaping and drying of the highly concentrated acrylic acid polymer solution in step (c) is conducted by a combination of contact drying and fluidized bed drying.

One such process is CFT—“Combi Fluidization technology”—developed by the company BUSS. Combi Fluidization technology combines contact drying with fluidized bed drying and is employed, for example, in the economical treatment of sludges and pastes that are difficult to handle. The fluidized bed in the horizontal apparatus is generated mechanically by means of a rotating paddle system. The process can be operated at atmospheric pressure or under reduced pressure. The main element of Combi Fluidization technology is the CFT drier. This apparatus is filled with dried product which is then fluidized by the rotor. The wet material is metered into the hot fluidized bed, immediately encapsulated by the dry product, and distributed and dried by the bed motion within the initial charge of dry material. The encapsulation of the wet feed product substantially prevents formation of tacky phases and direct contact of wet material with the heating surface, where it forms crusts. The entire operation is comparable to conventional drying with an external backmixing unit. In Combi Fluidization technology, however, there is no expenditure of external mechanical energy. Cleaning of the vapor is integrated within the dry space of the CFT drier. In this way, problem-free further processing of the vapor obtained by condensation or rectification is possible.

The drying of the highly concentrated, highly viscous polymer solution in the CFT drier gives rise to the following advantages over standard drying methods such as spray drying and spray pelletization:
energy saving of 40% to 50% by virtue of smaller amounts of water to be evaporated;
no offgas stream to be reprocessed;
smaller apparatus sizes and hence less space required;
establishment of particle size and residual moisture content by virtue of the process parameters during the drying in the CFT drier;
low-dust product.

In a particularly preferred embodiment of the invention, step (c) is thus conducted by treating the highly concentrated acrylic acid polymer solution in a CFT drier.

In a further embodiment of the process of the invention, the shaping and drying of the highly concentrated acrylic acid polymer solution in step (c) is conducted as a drying operation in a drum drier with subsequent shaping by compaction.

The drying step can be effected in a twin-drum drier. In the case of drying in a twin-drum drier, the hot polymer solution is applied uniformly from above between the heated rotating drums. The water evaporates during the partial rotation of the drum. The dried polymer is detached from the drums with a scraper. The solids thus formed are processed further in a downstream shaping process.

The choice of shaping process depends on the particle size of the product from the drier and the desired product properties after the shaping.

A suitable shaping process is comminution in a rotor sieve pelletizer. Rotor sieve pelletizers are used as comminuting unit for soft to medium-hardness products for the purpose of comminution with a low level of fine grains and oversize. The apparatus consists essentially of a rotor with facings set at an oblique angle, said rotor having an U-shaped surround in the lower portion of a supported sieve mesh or perforated specialty sheet metal. The rotor crushes the applied product in the form of large pieces against the surround and passes the pre-crushed material through a sieve mesh, so as to form an oversize-free end product in a narrow grain spectrum.

A further suitable shaping process is compaction by press agglomeration. In press agglomeration, pressing tools exert sufficiently great external forces on a generally dry bed or a pile of bulk material that a very large number of contacts with very small contact distances form between the particles of the bed. This at first reduces the proportion of cavity volume (porosity); in addition, the primary particles can also be comminuted when they are brittle, and in that case fill the interstitial spaces. Plastically deformable particles deform in such a way that they have facial contact. Even at the contact sites of brittle particles, microplastic deformations take place, which lead to an increase in the contact areas. The bonding forces that play a role here are van der Waals forces and electrostatic attraction forces. They can become relatively large in the case of small contact areas and facial contact. However, the van der Waals forces in particular have a very small range and are therefore particularly distance-sensitive. Consequently, suitable binders are still used in press agglomeration in many cases. If the force bearing on the compact is removed, there is partial elastic recovery. The extent of this recovery is dependent on the material and pressing force.

In the press agglomeration method, the characteristic properties such as strength, abrasion or apparent density for the desired end use of the compacted product can be achieved via various principles of action:
(1) press agglomeration in closed form with geometrically limited compaction, as in ram presses and tablet presses;
(2) press agglomeration in an open shaping channel with force-limited compaction owing to the resistance of the pressed strand in the shaping channel ram and punch presses;
(3) press agglomeration by roll pressure in roll presses.

In a further embodiment of the process of the invention, the shaping and drying of the highly concentrated acrylic acid polymer solution in step (c) is conducted as a shaping operation by piezo droplet generators/strand pelletization with subsequent fluidized bed drying.

Shaping by means of piezo droplet generators enables the production of monodisperse or deliberately polydisperse individual droplets of diameter 40 μm to 1000 μm. The droplets are produced by means of a piezo drive which is set in vibration. The droplet size depends upon factors including the size and shape of the modularly exchangeable nozzle opening. Piezo droplet generators are manufactured by companies including FMP TECHNOLOGY GMBH.

The direct comminution of strands which are produced by the pressing of high-viscosity fluids through nozzles or perforated sheets is a standard method for production of pellets or shaped bodies. The comminution is typically effected via a rotating blade which cuts off the emerging strands. The shaft of the rotating blade may be at the center or outside the center of the perforated sheet. Reference is correspondingly made to centric or eccentric pelletization.

In fluidized bed drying, the moist material is subjected to turbulent mixing in a hot gas stream directed upward, and as a result dries with high coefficients of heat and mass transfer. The gas velocity required depends essentially on the particle size and density. A perforated sheet (punched sheet, Conidur sheet, sheets made of fabric or sintered metal) prevents the solids from falling through into the hot gas space. Either the heat is supplied via the drying gas only or heat exchangers (tube bundles or plates) are additionally introduced into the fluidized bed.

Fluidized bed driers can be operated continuously or batchwise. In continuous operation, the residence time in the drier is from a few minutes up to a few hours. Fluidized bed driers are therefore also suitable for prolonged drying. If a narrow residence time distribution is required, the fluidized bed can be cascaded by separating plates or the product flow is approximated to ideal plug flow by means of meandering internals. Relatively large driers in particular are divided into a plurality of drying zones which are operated with different gas velocity and temperature. The last zone can then be utilized as a cooling zone. In the application region for the moist material, it should be ensured that no lumps occur. There are various ways of doing this, for example a locally higher gas velocity or a stirrer system.

In the case of systems that are relatively small or can be cleaned efficiently, filters can be integrated into the fluidized bed drier. Fluidized bed driers can be operated with vibration—the vibration supports product transport at low gas velocities (below the minimal fluidization rate) and low bed height, and can prevent formation of lumps. As well as vibration, it is also possible to employ a pulsed gas supply for reduction of the consumption of drying gas.

Another advantage is the lower evolution of dust in the method. The dust that arises in the process serves as pelletization seeds. In that case, the pellets form in the desired specification. In a sieving/grinding circuit downstream of the fluidized bed drier, the fines are removed and recycled into the fluidized bed. The coarse material is ground and also recycled back into the fluidized bed.

### EXAMPLES

The solids content was determined with the Mettler HR73 halogen balance at 150° C. with a measurement time of 1 hour. The viscosities reported were measured at 90° C. with an Anton Paar MCR 52 viscometer with a CC27 spindle at a shear rate of 100 s⁻¹.

GPC analysis conditions for determination of the molecular weight distribution:

The number average Mn and weight average Mw of the molecular weight distribution of the polymer are determined by means of gel permeation chromatography (GPC). The molecular weight distributions were determined by means of GPC on aqueous solutions of the polymers buffered to pH 7, using hydroxyethyl methacrylate copolymer network (HEMA) as stationary phase and sodium polyacrylate standards.

Calibration (determination of elution curve, molar mass vs. elution time) with sodium polyacrylate standards from PSS in the molecular weight range of 1250-1 100 000 Da, PSS Poly 5; as described in M. J. R. Cantow et al. (J. Polym. Sci., A-1, 5(1967) 1391-1394), but without the proposed correction for concentration.

Separation of the molecular weight distributions via
PSS Suprema precolumn
PSS Suprema 30
PSS Suprema 1000
PSS Suprema 3000

| | |
|---|---|
| Eluent: | distilled water buffered at pH 7.2 |
| Column temperature: | 35° C. |
| Flow rate: | 0.8 mL/min |
| Injection: | 100 μL |
| Concentration: | 1 mg/mL (sample concentration) |
| Detector: | DRI Agilent 1100 UV GAT-LCD 503 [260 nm] |

### Example 1

Inline neutralization and concentration of a polyacrylic acid solution with exploitation of the heat of neutralization:

A 52% by weight solution of polyacrylic acid (Mw=5000 g/mol) in water, prepared by solution polymerization of acrylic acid with sodium peroxodisulfate as initiator and sodium hypophosphite as chain transfer agent, is conveyed (300 g/h) together with aqueous 50% by weight NaOH (156 g/h) through a static mixer (Fluitec CSE-W helical mixer, I=1 m, d=6 mm). The neutralized polyacrylic acid solution (44% by weight) which has been heated to about 110° C. by the neutralization energy released and energy supplied additionally is collected in a precipitation vessel (6.4 L) heated to 120° C., this vessel having been provided with a relief valve which regulates the pressure in the vessel at 1.4 bar (abs.). The steam formed is discharged via this relief valve. The concentrated polyacrylic acid solution that has been neutralized to an extent of 97% and has a solids content of 70% by weight is discharged at 284 g/h via an outlet at the base of the precipitation vessel and heated to about 80 to 90° C. on the way to the discharge. The viscosity of the polyacrylic acid solution that has been neutralized to an extent of 97% at 90° C. is 2800 mPas.

### Example 2

Example 2 is executed in accordance with example 1. A 50% by weight solution of polyacrylic acid (Mw=6200 g/mol) in water is used, prepared by solution polymerization of acrylic acid with sodium peroxodisulfate as initiator and sodium hydrogensulfite as chain transfer agent. The concentrated polyacrylic acid solution that has been neutralized to an extent of 98% is discharged with a solids content of 70% by weight. The viscosity of the polyacrylic acid solution that has been neutralized to an extent of 98% at 90° C. is 3200 mPas.

### Example 3

The aqueous neutralized polyacrylic acid solution from example 2 is heated to 70° C. and conveyed into a drying tower through a nozzle at about 5 g/min. A chopping blade is mounted at a distance of 1 mm from the nozzle orifice and rotates at 1000 rpm. The metal parts of the drying tower are heated to 160° C. by heating strips mounted on the outside of the drying tower and the interior is purged with 15 m³/h of nitrogen preheated to 160° C. The solids formed are obtained in the form of irregular particles of diameter about 1 mm and length 1 to 4 mm. The solids content of the particles is 82% by weight. The particles are nontacky.

### Example 4

Under the conditions of example 3, it is possible to produce strands of 15 to 30 cm without the use of the chopping blade. These strands are removed from the drying tower and comminuted in a pelletizer (Collin TeachLine CSG171T). The particles obtained have a diameter of about 1 mm and a length of 0.5 to 1.5 mm. The solids content of the particles is 82% by weight. The particles are nontacky.

### Example 5

Under the conditions of example 4, it is possible to produce a continuous strand at a reduced nitrogen flow rate (0.5 m³/h). This strand is divided into strand pieces, dried in a desiccator (over silica gel) overnight and comminuted the next day in a pelletizer (Collin TeachLine CSG171T). The particles obtained have a diameter of about 1 mm and a length of 0.5 to 1.5 mm. The particles are nontacky.

### Example 6

The aqueous neutralized polyacrylic acid solution from example 2 is heated to 70° C. and discharged as a strand by means of pressure (N₂ 4-5 bar) through a PTFE hose (I=5 mm, dᵢₙₜₑᵣₙₐₗ=0.8 mm). The strand is applied continuously to a conveyor. The strand is divided into pieces and dried in a drying cabinet at about 100° C. overnight. The solids content of the pieces is about 91.5%. The pieces are nontacky.

### Example 7

3.4 kg/h of a 68% by weight aqueous neutralized polyacrylic acid solution (Mw=6000 g/mol), prepared according to example 2, is introduced continuously from a stirred 30 liter vessel heated to 90° C. via a heated conduit from above into the open 5 liter laboratory CFT drier. The apparatus is initially charged with 2.4 kg of polyacrylic acid pellets (Sokalan PA 25 CL pellets from BASF SE). The fill level is 74%. The shaft with mixing tools that rotates at 80 rpm in the drier distributes the high-viscosity solution within the apparatus. The steam heating of the drier wall and the shaft is set to 165 to 185° C. The solution dries at product temperature 145° C. and is subsequently discharged batchwise. The vapor gas stream is drawn off via a vapor filter and collected in a condenser. The solids thus produced exhibit a broad particle size distribution. The residual moisture content is 6% by weight. This is determined with a Mettler HR73 halogen balance at 150° C. after 1 hour.

In a subsequent step, the polyacrylic acid pellets are sieved off to particles larger than 1.25 mm, and the coarse material obtained is comminuted by means of a sieve pelletizer having a 1.25 mm sieve. This gives rise to a low-dust pelletized material having good free flow.

### Example 8

An aqueous neutralized 70% by weight polyacrylic acid solution (Mw=6000), prepared according to example 2, was introduced batchwise in 300 g to 400 g portions at product temperature 80° C. from above between two drums heated to 180° C. These rotated in opposite directions at 4-5 1/min. The water evaporated during the partial rotation of the drums. The dried polymer in the form of flakes was detachable very readily from the drums. The solid polymer thus formed had a residual moisture content of 14.4%. This was determined with a Mettler HR73 halogen balance at 150° C. with measurement time 1 hour. In a subsequent step, the product in the form of flakes was sieved to give particles larger than 1.0 mm and the coarse material thus obtained was comminuted by means of a sieve pelletizer with a 1.0 mm sieve. This gave rise to a low-dust product having good free flow.

### Example 9

In a droplet generator from FMP TECHNOLOGY GMBH, an aqueous solution of polyacrylic acid pellets (Sokalan PA 25 CL pellets from BASF SE) having a solids content of 60% by weight was processed. This was done using nozzles with diameter 200 μm, 500 μm and 1000 μm. For all the nozzle sizes, it was possible to generate monodisperse droplets. The droplet diameter was 208 μm in the case of the 200 μm nozzle, 565 μm in the case of the 500 μm nozzle and 897 μm in the case of the 1000 μm nozzle. The droplets produced in this way can subsequently be dried in order to produce solid, nontacky particles.

1. A process for preparing solid acrylic acid polymers comprising:
(a) preparing an aqueous acrylic acid polymer solution having a solids content of 30% to 70% by weight by free-radical polymerization,
(b) neutralizing the aqueous acrylic acid polymer solution at least partly by adding a base, which results in release of a heat of neutralization, and concentrating the aqueous acrylic acid polymer solution by evaporating water to give a highly concentrated acrylic acid polymer solution having a solids content of 60% to 80% by weight,
(c) shaping and drying the highly concentrated acrylic acid polymer solution.

2. The process according to claim 1, wherein the aqueous acrylic acid polymer solution is concentrated in step (b) with exploitation of the heat of neutralization.

3. The process according to claim 1, wherein step (b) is conducted in two component steps (b-1) and (b-2), wherein component step (b-1) comprises a mixing of the aqueous acrylic acid polymer solution with a base and an at least partial neutralization of the acrylic acid polymer solution, and component step (b-2) comprises concentrating the acrylic acid polymer solution that has been heated by the heat of neutralization by evaporating water.

4. The process according to claim 3, wherein component step (b-1) is conducted at a higher pressure than component step (b-2).

5. The process according to claim 4, wherein component step (b-1) is conducted at a pressure of 1.5 to 10 bar and component step (b-2) at a pressure of 1 to 5 bar, wherein a pressure differential between the first and second component steps is 0.5 to 5 bar.

6. The process according to claim 3, wherein the aqueous acrylic acid polymer solution is heated in component step (b-1) to a temperature in a range from 100 to 150° C.

7. The process according to claim 1, wherein step (b) comprises the steps of:
(b-1) adding a base and mixing the base with the aqueous acrylic acid polymer solution at a pressure in a range from 5 to 10 bar and at least partly neutralizing and heating the aqueous acrylic acid polymer solution to a temperature in a range from 120 to 140° C.,
(b-2) expanding the aqueous acrylic acid polymer solution to a pressure in a range from 1 to 2.5 bar and concentrating the aqueous acrylic acid polymer solution by evaporating water with exploitation of the heat of neutralization.

8. The process according to claim 2, wherein step (b-1) is conducted in a tubular or loop reactor with internal mixing elements and step (b-2) in a gas separation vessel.

9. The process according to claim 2, wherein steps (b-1) and (b-2) are conducted in a stirred tank reactor.

10. The process according to claim 1, wherein the base added in step (b) is a sodium hydroxide solution.

11. The process according to claim 1, wherein the drying of the highly concentrated acrylic acid polymer solution in step (c) is conducted up to a solids content of 80% to 100% by weight.

12. The process according to claim 1, wherein the shaping and drying of the highly concentrated acrylic acid polymer solution in step (c) is conducted by a combination of contact drying and fluidized bed drying.

13. The process according to claim 12, wherein step (c) is conducted in a CFT dryer.

14. The process according to claim 1, wherein the shaping and drying of the highly concentrated acrylic acid polymer solution in step (c) is conducted in the form of a drying operation in a drum dryer with subsequent shaping by compaction.

15. The process according to claim 1, wherein the shaping and drying of the highly concentrated acrylic acid polymer solution in step (c) is conducted in the form of a drying operation in a drum dryer with subsequent shaping by comminution in a rotor sieve pelletizer.

16. The process according to claim 1, wherein the shaping and drying of the highly concentrated acrylic acid polymer solution in step (c) is conducted by shaping by means of piezo droplet generators/strand pelletization with subsequent fluidized bed drying.

17. An at least partly neutralized, aqueous acrylic acid polymer solution having a solids content of 60% to 80% by weight and a viscosity of 300 to 6000 mPas at 90° C.

18. An at least partly neutralized, aqueous acrylic acid polymer solution having a solids content of 60% to 80% by weight and a viscosity of 300 to 6000 mPas at 90° C., obtainable by steps (a) and (b) of the process according to claim 1.
